(19) United States
(12) Patent Application Publication
(10) Pub. No.: US 2012/0182205 A1
(43) Pub. Date: Jul. 19, 2012

(54) CONTEXT DRIVEN HEADS-UP DISPLAY FOR EFFICIENT WINDOW INTERACTION

(75) Inventor: Gaute Johannes Gamst, Oslo (NO)

(73) Assignee: Schlumberger Technology Corporation, Sugar Land, TX (US)

(21) Appl. No.: 13/008,386

(22) Filed: Jan. 18, 2011

(51) Int. Cl. G09G 5/00

(52) U.S. Cl. 345/7

(57) ABSTRACT

The present disclosure relates to methods and systems for interacting with software applications, and more specifically, to “context-driven” heads-up displays for efficient window interaction. In some embodiments, a method includes operating a software application; determining a context of usage of the software application; and displaying a heads-up display on a display device, the heads-up display including one or more user-selectable indicators, each user-selectable indicator being associated with an operation of the software application, at least one of the one or more user-selectable indicators being displayed based on the determined context of usage. In further embodiments, the heads-up display may have a plurality of user-selectable indicators circumferentially disposed about a dynamically-determined user-indicated location on the display device.

### FIELD OF THE INVENTION

The present disclosure relates to methods and systems for interacting with software applications operating on electronic devices, and more specifically, to “context-driven” heads-up displays for efficient window interaction.

### BACKGROUND

In a wide variety of environments, people interact with computers via a user interface device (e.g. mouse, joystick, trackball, etc.) that allows the person to control a position of an indicator (e.g. a cursor) on a display of an electronic device to make desired selections. For example, in various petroleum science applications, an analyst may interact with data by selecting tools from one or more menus displayed about a periphery of a display window. On current applications, the various user interface buttons, tools, and menus are arranged outside (or about the periphery) of the window, forcing the analyst to make relatively large mouse movements to make selections, possibly disrupting the analyst's focus and the flow of work.

Heads-up displays (HUDs) are currently used in software, particularly computer games, to provide information to a user. The term “heads-up display” generally refers to a transparent display that presents data without requiring users to look away from their usual viewpoints. Although desirable results have been achieved using such conventional systems and methods, there is room for improvement.

### SUMMARY

The present disclosure relates to methods and systems for interacting with software applications, and more specifically, to “context-driven” heads-up displays for efficient window interaction. Embodiments of methods and systems in accordance with the teachings of the present disclosure may advantageously improve a user's interaction with a software application by providing rapid access to available choices, or by suggesting or emphasizing next-likely actions, or by providing icons tailored to a user's preferences or history of useage, which may thereby improve the user's concentration on a task at hand, and the overall flow of the user's work.

For example, in some embodiments, a method of interacting with a software application in accordance with the present disclosure includes operating a software application; determining a context of usage of the software application; and displaying a heads-up display on a display device, the heads-up display including one or more user-selectable indicators, each user-selectable indicator being associated with an operation of the software application, at least one of the one or more user-selectable indicators being displayed based on the determined context of usage. In further embodiments, displaying a heads-up display on a display device includes displaying a heads-up display having a plurality of user-selectable indicators circumferentially disposed about a dynamically-determined user-indicated location on the display device.

This summary is merely intended to provide a brief synopsis of one or more possible implementations of, and possible aspects or advantages of, systems and methods in accordance with at least some embodiments of the present disclosure. This summary is further intended as merely an aid to the reader's understanding of such particular embodiments, and is not intended to define or limit other embodiments of systems and methods disclosed elsewhere herein.

### BRIEF DESCRIPTION OF THE DRAWINGS

The detailed description is described with reference to the accompanying figures, in which similar or identical reference numerals may be used to identify common or similar elements.

FIG. 1 shows a flowchart of an embodiment of an exemplary process in accordance with the teachings of the present disclosure.

FIG. 2 shows a schematic view of an embodiment of a display environment in accordance with the teachings of the present disclosure.

FIG. 3 shows a representative display having a heads-up display in accordance with an embodiment of the present disclosure.

FIG. 4 shows an enlarged view of the heads-up display of FIG. 3.

FIGS. 5 through 12 show further embodiments of heads-up displays in accordance with the teachings of the present disclosure.

FIG. 13 shows a representative computing environment in which a heads-up display in accordance with the teachings of the present disclosure may be implemented.

### DETAILED DESCRIPTION

This disclosure is directed to “context-driven” heads-up displays for efficient window interaction. Embodiments of heads-up displays (HUDs) in accordance with the teachings of the present disclosure advantageously provide new ways to drive the interactive workflows in various software applications that may enable a user to maintain or improve their focus, and may reduce (or minimize) mouse and/or hand movements to improve efficiency of the work flow process.

More specifically, in at least some embodiments, a “context-driven” heads-up display (HUD) in accordance with the present disclosure may be displayed by an electronic device in close proximity to a mouse cursor (when mouse driven) or in close proximity to a touch point (when touch driven), minimizing the travel time for selecting tools in a window. Such HUDs may be “context-driven” such that relevant tools and options are displayed to a user based on the current context (e.g. displayed object, window type, active process, previous user actions and object/user history), and may be distributed circumferentially about the cursor (or touch point) for relatively rapid selection of options.

A wide variety of interaction options may be provided using embodiments of HUDs in accordance with the present disclosure. For example, in at least some embodiments, more relevant tool options may be highlighted or otherwise emphasized (e.g. size, position, color, bolding, brightness, etc.). These and other aspects of embodiments of HUDs in accordance with the present disclosure are described more fully below.

Exemplary Processes

FIG. 1 is a flowchart of an embodiment of an exemplary process 100 in accordance with the teachings of the present disclosure. In this embodiment, the process 100 includes invoking a software application operating on an electronic device at 102. In some embodiments, the software application may be a simulation tool used for scientific or engineering analyses, such as, for example, a geological and geophysical modeling application, a petroleum reservoir modeling application, a structural analysis application, a fluid dynamics application, or any other suitable application for performing scientific or engineering analyses. In alternate embodiments, the software application may be a word-processing application (e.g. Word®, WordPerfect®, etc.), a business or accounting application (e.g. Quicken®, Quickbooks®, etc.), an Internet browser (e.g. Internet Explorer®, Netscape Navigator®, etc.), a video game, or any other suitable software application.

The process 100 may further include determining a context of usage of the software application at 104. For example, in some embodiments, the context may be based on one or more actions taken (or activities performed) by a user, such as a location or “hover point” of an indicator (or touch point) on the display, the user's history of usage (recent or long-term), user-indicated preferences, user profile, or other user-specific characteristics. Alternately, such as during initial start-up of the software application or when no user-specific characteristics are available, the context may be determined based on one or more assumptions or default characteristics.

As further shown in FIG. 1, the process 100 includes displaying (or projecting) a context-based heads-up display (HUD) on a display of the electronic device at 106. In some embodiments, the HUD may be displayed upon a request by the user of the software application, such as by clicking a mouse button, tapping or touching a touch-driven device, speaking a particular word or phrase, or any other suitable command.

In alternate embodiments, the displaying of the HUD at 106 may be performed automatically by the software application based on, for example, one or more aspects of the context of the software application. The one or more aspects of the context of the software application may include, for example, one or more choices made by the user, a series of actions by the user, a particular context of the software application, or any other suitable basis. Of course, in further embodiments, the HUD may be displayed substantially continuously during the user's use of the software application.

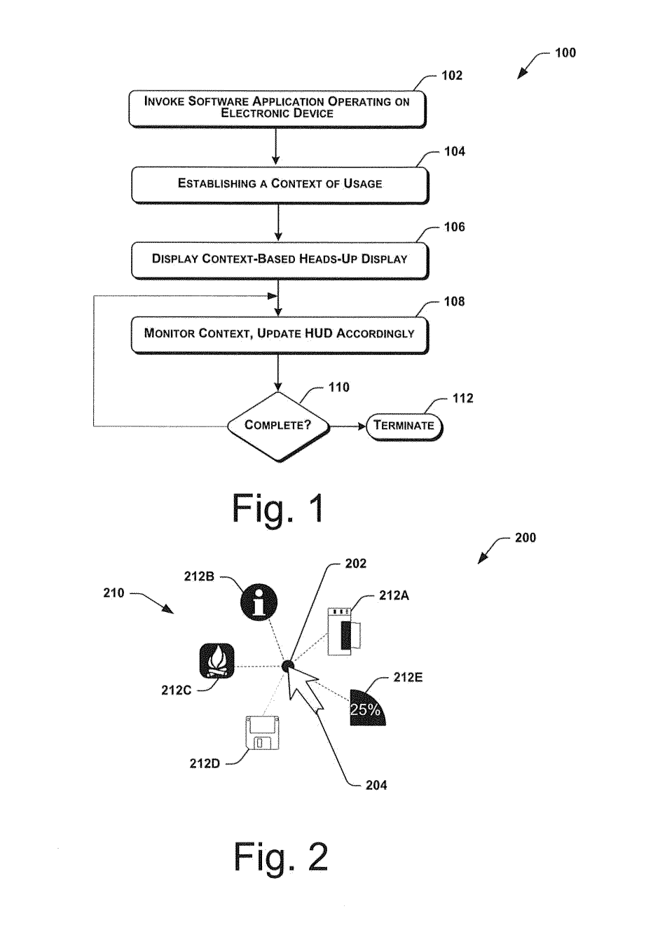

FIG. 2 shows a schematic view of an embodiment of a display environment 200 in accordance with the teachings of the present disclosure. In this embodiment, the display environment 200 includes a hover point 202 over which a user has positioned an indicator (or cursor) 204, and a heads-up display (HUD) 210 displayed about the hover point 202. In the embodiment shown in FIG. 2, the HUD 210 includes a plurality of choice icons 212 (in this case, five) spaced apart from, and circumferentially disposed about, the hover point 202. Each of the choice icons 212 represents a different action or operation that the user may elect to perform. In accordance with the teachings of the present disclosure, the choice icons 212 which are displayed in the HUD 210 may depend upon, and may automatically change according to, the context of the software application (e.g. determined at 104).

Referring again to FIG. 1, the process 100 further includes monitoring the context of the user's activities with respect to the software application, and updating the displayed HUD (if the HUD is being displayed) in accordance with the context at 108.

For example, in some embodiments, the context may indicate that the user is creating a model for simulation and analysis. Based on the monitored context (at 108), the software application may display a HUD that includes one or more choice icons associated with options for creating or defining a model, such as, for example, a line drawing icon, a shapes icon, a grid defining icon, an assigning material properties icon, a boundary conditions icon, or other suitable model-creation icons. Continued monitoring of the context (at 108) may indicate that the user has completed the creation of the model, and is ready to perform analytical studies of the model, in which case the software application may update the displayed HUD to include choice icons associated with various choices involved in analytical studies (e.g. applied loads, pressures, temperatures, viscous models, compressibility models, etc.). Further monitoring of the context (at 108) may indicate that the user wishes to study the results of the analytical studies, in which case the HUD may be updated to provide choice icons associated with studying results, suc as graphing results, performing arithmetic operations (e.g. integrating forces, determining maxima or minima, etc.), printing results, storing results, or any other suitable choices.

In the embodiment shown in FIG. 1, the process 100 determines whether the user has completed operations with the software application at 110, and if so, terminates (or continues to other operations) at 112. If the user has not completed operations at 110, then the process 100 returns to monitoring the context and updating the displayed HUD at 108 until the user has completed operations.

It will be appreciated that embodiments of methods and systems in accordance with the teachings of the present disclosure may provide advantages over prior art methods of displaying choices to a user. For example, because the choice icons of the heads-up display are circumferentially disposed about the hover point of the cursor (or indicator), a user is able to view available choices without significant eye movement to the edges of a window, and is able to select from the available choices without significant travel of the cursor (or indicator). As a result, the user's concentration on the task at hand may be improved, and the overall flow of the user's work may be improved.

In addition, because the heads-up display is context-driven, a more appropriate or suitable set of choice icons may be displayed in the HUD than may otherwise be presented in a conventional HUD. Since the context may include various user-specific characteristics, which may be determined by the user's usage history, user-specified preferences, user-profile, or other suitable ways, the context may result in the displaying of the HUD that is more appropriately tailored to the user's needs and preferences. Therefore, in this additional way, the user's concentration on the task at hand may be improved, and the overall flow of the user's work may be improved.

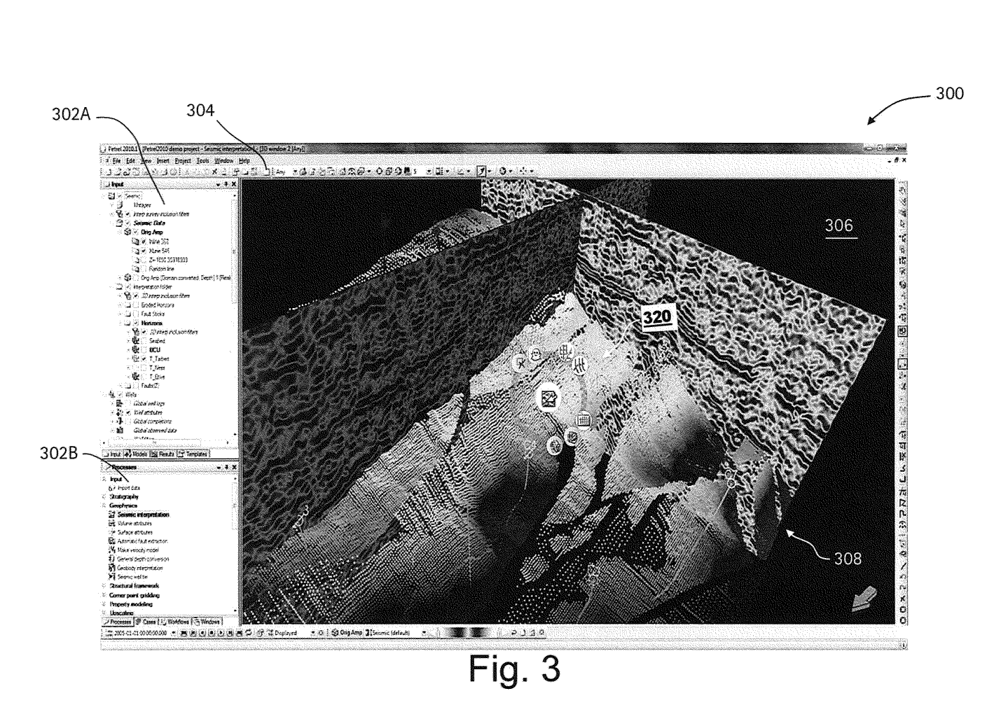

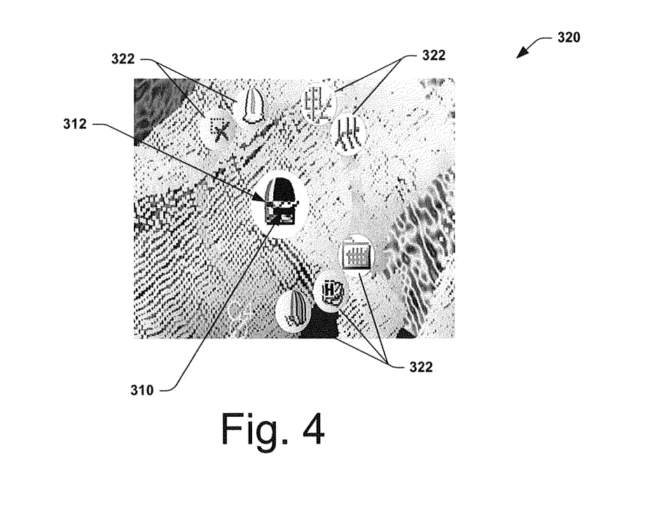

Further embodiments of methods and systems in accordance with the present disclosure may include additional aspects that further assist and improve a user's interaction with a software application. For example, FIG. 3 shows a representative display 300 having a heads-up display 320 in accordance with an embodiment of the present disclosure. FIG. 4 shows an enlarged view of the heads-up display 320 of FIG. 3. The display 300 may be provided by any suitably-equipped software application. For example, in the embodiment shown in FIG. 3, the display 300 is provided by a software application for performing scientific or engineering analysis, or more specifically, a geosciences application (e.g. the Petrel® geosciences application developed by Schlumberger Information Solutions). In alternate embodiments, other software applications, or other types of software applications, may be used.

With reference to FIG. 3, the display 300 generally includes first and second conventional menus 302A, 302B disposed along a left-hand side of the display 300, and a conventional toolbar 304 along an upper portion of the display 300. A work window 306 of the display 300 contains a three-dimensional view of a simulation model 308.

As noted above, if the user desires to select an option available on either the conventional menus 302 or the conventional toolbar 304, the user must traverse the cursor (or other indicator), and the user's gaze, across a portion of the display 300 to an edge of the work window 306 to make a selection, which may detract from the user's concentration, and may diminish the overall flow of the user's work. Conversely, the heads-up display 320 which appears proximate the cursor (or other indicator) may advantageously allow the user to make selections with greater ease and less distraction.

In operation, as best shown in FIG. 4, a cursor 310 is positioned over a hover point located on the simulation model 308. Appearing either at the user's request or automatically, the heads-up display 320 provides a context-based suite of option icons 322 to the user. In addition, a current-action (or most-recent-action) icon 312 may be displayed at the hover point. The option icons 322 of the heads-up display 320 are radially spaced-apart from, and positioned peripherally (or circumferentially) about, the cursor 310 (or hover point).

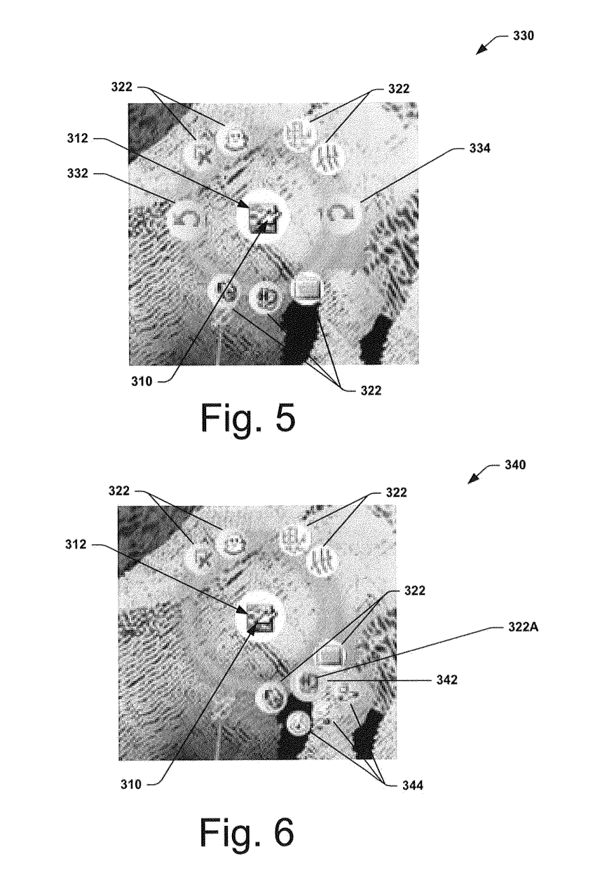

In various possible embodiments, the heads-up display in accordance with the present disclosure may provide various capabilities to assist and improve a user's interaction with the software application. For example, in some embodiments, the heads-up display 320 may help guide a workflow of the user by highlighting (or otherwise emphasizing) one or more of the option icons 322 associated with a next-likely (or next-mandatory) action of the user. In further implementations, the contents of the heads-up display 320 (e.g. number and/or type of choice icons 322) may vary according to process changes by the user. In still further implementations, the heads-up display 320 may enable interactive tools on the work window 306, may provide undo and/or redo actions (e.g. see FIG. 5, in which the heads-up display 330 includes an undo icon 332 and a redo icon 334), may provide capabilities for information, interrogation, or operation on objects in context, may enable changing styles and/or display of objects, may identify last used and/or likely needed data objects, may traverse a hierarchical selection of data or possible activities, or may provide any other suitable functionalities.

In still further implementations, the available options included in the heads-up display can be filtered by usage patterns (or other context-driven characteristics) to ensure relevance of the options displayed. The relative relevance of the options can be indicated to the user through various visualization parameters (e.g. transparency, color, size, brightness, etc). Furthermore, in at least some embodiments, a heads-up display in accordance with the present disclosure may be customizable (settings) by the user so that certain option types can be enabled or disabled according to an individual user's preferences.

As noted above, in some embodiments, heads-up displays in accordance with the teachings of the present disclosure may remain hidden until requested by the user, and once requested, will show up around the mouse cursor or touch point. The way the heads-up display is activated may vary depending on the software application, the electronic device, or other factors, and may be customizable in accordance with a user's preferences, but likely options include:
Thumb touch+index finger touch and drag to bring the heads-up display into view; release index finger to select=>heads-up display will go away on release.
CTRL key on the keyboard shows heads-up display, mouse click to select; On mouse release the heads-up display will go away.
Dragging and rotating an open (no icon) portion of the “wheel” formed by the icons of the heads-up display rotates the wheel allowing different icons or activities to be on top.
Right mouse button to bring heads-up display into display, left to select.
Voice commands: “show menu,” “show HUD,” “dismiss HUD,” etc.

In sonic embodiments, a heads-up display in accordance with the present disclosure may provide a multilevel hierarchy so that further ease of use and feature richness can be achieved. For example, FIG. 6 shows an enlarged view of a heads-up display 340 in an alternate configuration in accordance with the present disclosure. In this embodiment, the choice icon 322A (e.g. associated with a “horizontal interpretation” functionality) has been activated or selected by the user. A relatively-brighter ring or band 342 is provided about the activated choice icon 322A, and additional sub-choice icons 344 associated with the activated choice icon 322A are displayed proximate to (and radially outwardly spaced from) the activated choice icon 322A. Thus, the heads-up display 340 provides a first level of choice icons 322 circumferentially distributed about the cursor (or touch point) 310 at a first radial distance, and a second level of sub-choice icons 344 circumferentially distributed at a second radial distance, thereby providing a multilevel hierarchy of choices.

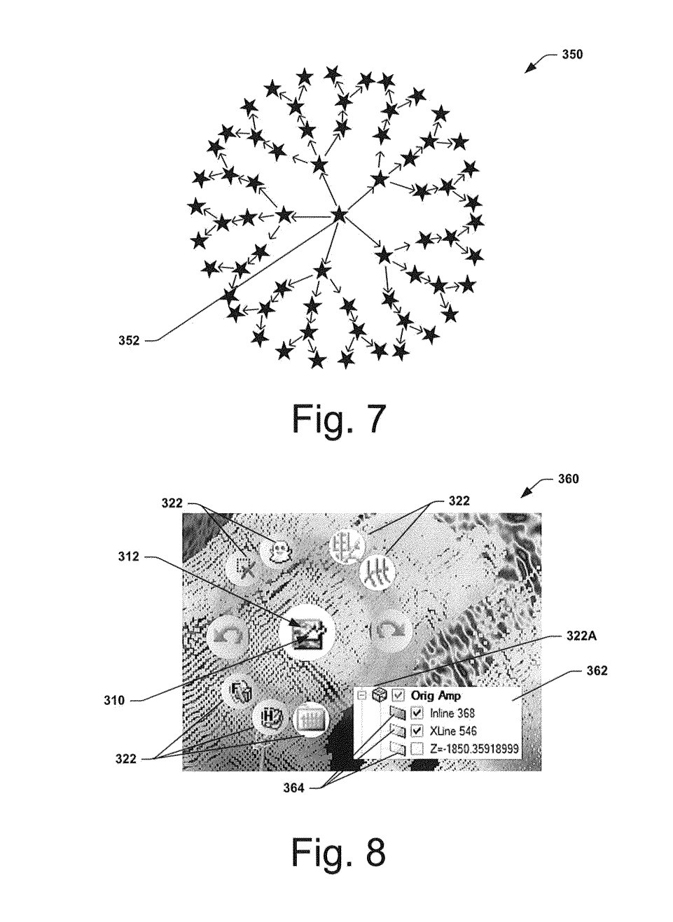

Although the heads-up display 340 of FIG. 6 shows a two-level hierarchy of choice icons, in alternate embodiments, an even greater number of hierarchical levels of choice icons may be provided. For example, FIG. 7 shows a schematic representation of a heads-up display 350 having four levels of choice icons disposed about a cursor location 352. Of course, in alternate embodiments, any desired number of levels of icons may be employed. In some embodiments, all four levels of choice icons may be visible when the heads-up display 350 is activated. Alternately, as described above with respect to FIG. 6, in some embodiments only the first level choice icons may be visible unless or until a user activates a choice icon causing outer-level sub-choice icons to appear.

In addition, a multilevel hierarchy may be provided in alternate ways. For example, FIG. 8 shows an enlarged view of a heads-up display 360 in accordance with another embodiment of the present disclosure. In this embodiment, the choice icon 322A has been activated by the user, causing a table 362 with several sub-choice icons 364 to appear. Thus, the heads-up display 360 provides a first level of choice icons 322 circumferentially distributed about the cursor (or touch point) 310 at a first radial distance, and a table 362 of sub-choice icons 364 distributed proximate the selected choice icon 322A, thereby providing yet another embodiment of a multilevel hierarchy of choices easily accessible to the user.

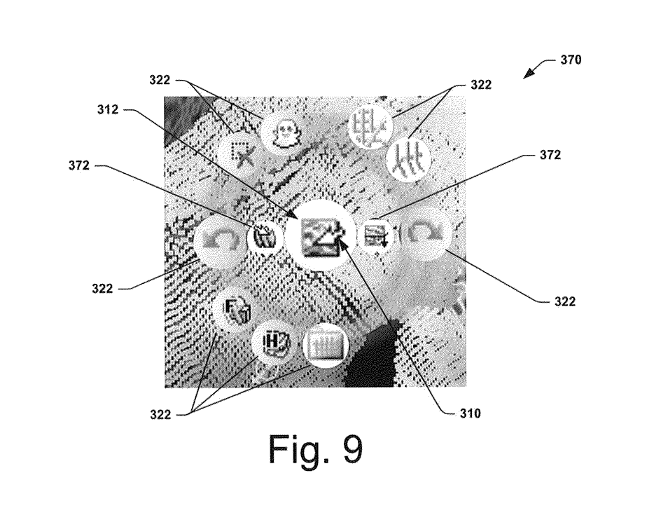

In another aspect, a heads-up display in accordance with the present disclosure may provide quick access to one or more “most likely next processes.” For example, FIG. 9 shows an enlarged view of a heads-up display 370 in an alternate configuration in accordance with the present disclosure. In this embodiment, the heads-up display 370 includes the plurality of choice icons 322 disposed about the cursor (or touch point) 310 and the current choice (or most-recently-used) icon 312. In addition, a most-likely-next-process icon 372 is displayed on either side of the current choice (or most-recently-used) icon 312. Thus, in this additional way, embodiments of systems and methods in accordance with the present disclosure may further improve a user's interaction with a software application, and with an overall flow of work by the user.

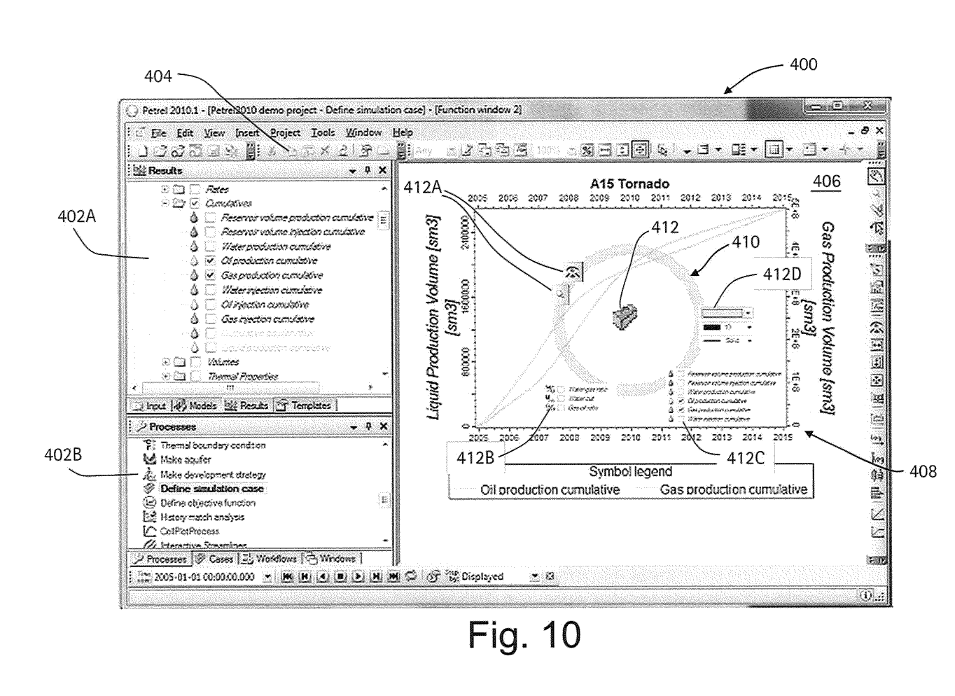

Embodiments of heads-up displays in accordance with the present disclosure may be configured for displaying and analyzing data. For example, FIG. 10 shows a representative display 400 having a heads-up display 410 in accordance with another embodiment of the present disclosure. In this embodiment, the display 400 generally includes first and second conventional menus 402A, 402B disposed along a left-hand side of the display 400, and a conventional toolbar 404 along an upper portion of the display 400. A work window 406 of the display 400 contains a graph 408, and the heads-up display 410 is superimposed over a portion of the graph 408.

The heads-up display 410 includes a plurality of option indicators 412 disposed about a central icon 414 that represents a current (or most-recently used) tool or operation. The central icon 414 may generally coincide with a cursor position (or touch point). In the embodiment shown in FIG. 10, the option indicators 412 include a pair of choice icons 412A associated with options for viewing results on the graph 408, a menu of arithmetic operations 412B for performing various arithmetic operations on results shown in the graph 408, a menu of various data 412C that may be selected for display on the graph 408, and a menu of various display options 412D for displaying the selected data on the graph 408.

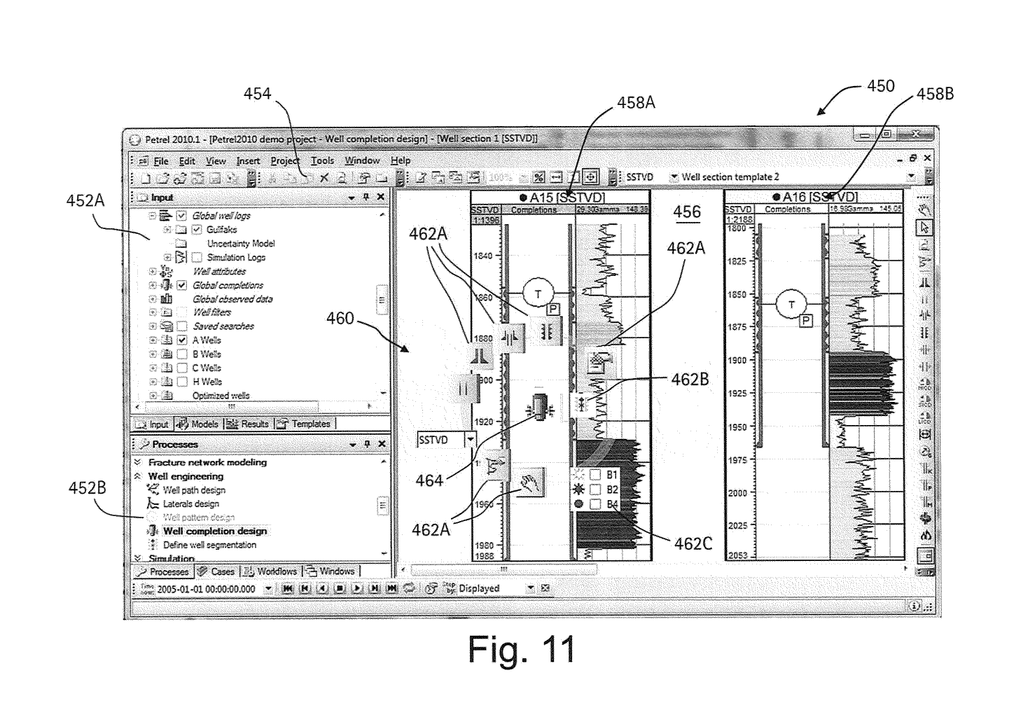

Similarly, embodiments of heads-up displays in accordance with the present disclosure may be configured for defining models or problems for analysis. For example, FIG. 11 shows a representative display 450 having a heads-up display 460 in accordance with another embodiment of the present disclosure. In this embodiment, the display 450 generally includes first and second conventional menus 452A, 452B, a conventional toolbar 454, and a work window 456 that contains a first depiction of data representing a first well model 458A, and a second depiction of data representing a second well model 458B. The heads-up display 460 is superimposed over a portion of the first depiction of data representing the first well model 458A.

Again, the heads-up display 460 includes a plurality of option indicators 462 disposed about a central icon 464 that represents a current (or most-recently used) tool or operation. The central icon 464 may generally coincide with a cursor position (or touch point). In the embodiment shown in FIG. 11, the option indicators 462 include several choice icons 462A associated with defining various aspects of the first well model 458A, a most-likely-next-operation icon 462B, and a menu of various characteristics 462C that may be assigned to the first well model 458A. More specifically, the heads-up display 460 may show icons associated with, for example, completion tools, well log tools, toggles for toggling some wells on and off, a drop down for the domain of the window, and/or a short cut to the well section template driving the window contents. The heads-up display 460 shown in FIG. 11 is one example of a virtually unlimited number of possible embodiments that may be conceived for implementing heads-up displays in software applications for defining models or problems for analysis in accordance with the teachings of the present disclosure.

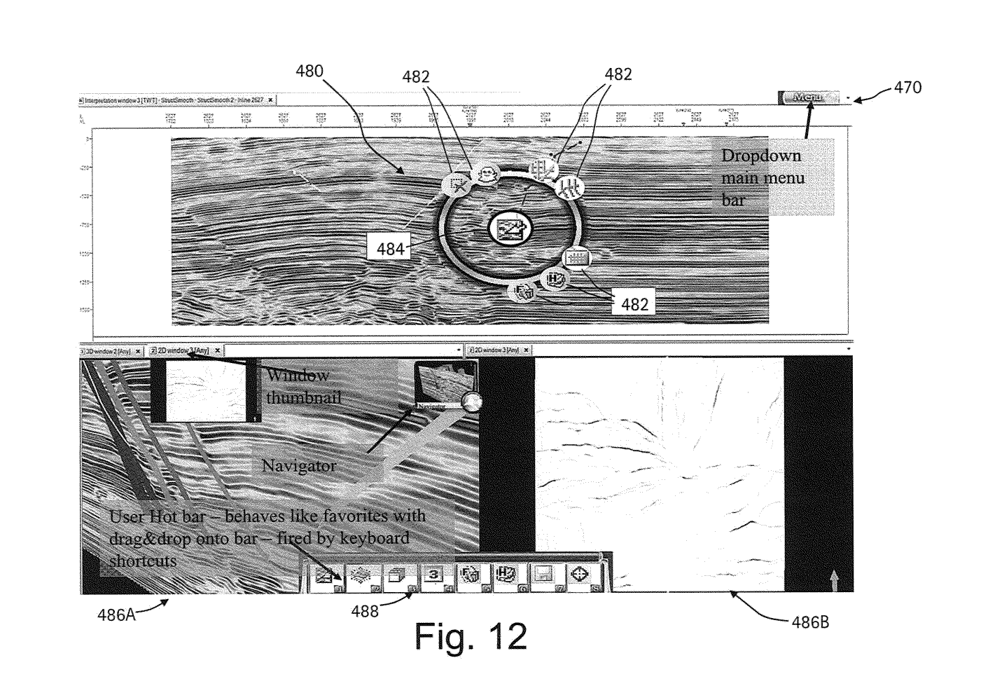

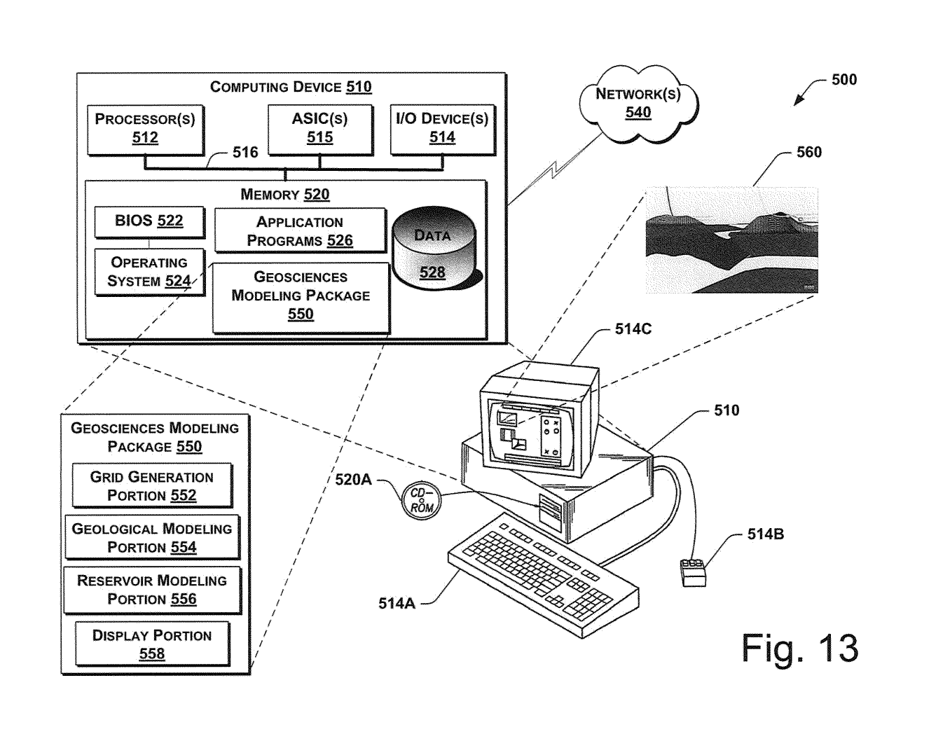

FIG. 12 shows a representative display 470 having a heads-up display 480 in accordance with another embodiment of the present disclosure. In this embodiment, the display 480 generally includes a plurality of choice icons 482 disposed about a cursor, and a most-recently-invoked icon 484 coincident with the cursor. In at least some embodiments, when one or more of the choice icons 482 are activated by the user, one or more of navigational window(s) 486, or a hotbar 488 (or a customizable favorites bar) with hot keys may be displayed. Thus, heads-up displays 480 in accordance with the present disclosure may be adapted to provide pop-up windows or toolbars to further facilitate the flow of work being performed by a user.

As described above, embodiments of methods and systems for interacting with software applications operating on electronic devices as disclosed herein may provide considerable advantages over prior art methods. Embodiments in accordance with the present disclosure may, for example, improve a user's interaction with a software application by providing easy and rapid access to available choices, or by suggesting or emphasizing next-likely actions, or by providing icons tailored to a user's preferences or history of useage, thereby improving the user's concentration on the task at hand, and the overall flow of the user's work.

Exemplary Environments

Embodiments of methods and systems in accordance with the teachings of the present disclosure may be implemented in virtually any interactive software application or operating environment. For example, as noted above, embodiments in accordance with the present disclosure may be implemented in any suitable interactive software application, including but not limited to, device control applications, word-processing applications, business or accounting applications, Internet browsers, video games, or virtually any other software applications. Similarly, embodiments in accordance with the present disclosure may be implemented in a wide variety of electronic devices, including but not limited to, desktop and laptop computers, mainframes, hand-held devices (e.g. cell phones, iPods®, personal data assistants, etc.), gaming devices (e.g. Xbox®, Play Station®, etc.), navigational devices (e.g. global positioning system devices, etc.), appliances (e.g. televisions, ovens, automated tell machines, etc.), special-purpose devices (e.g. automated teller machines, gas pumps, etc.), or virtually any other suitable menu-driven devices.

More specifically, systems and methods for interacting with software applications in accordance with the teachings of the present disclosure may be implemented in a variety of computational environments. For example, FIG. 13 illustrates an exemplary environment 500 in which various embodiments of systems and methods in accordance with the teachings of the present disclosure can be implemented. In this implementation, the environment 500 includes a computing device 510 configured in accordance with the teachings of the present disclosure. In some embodiments, the computing device 510 may include one or more processors 512 and one or more input/output (I/O) devices 514 coupled to a memory 520 by a bus 516. One or more Application Specific Integrated Circuits (ASICs) 515 may be coupled to the bus 516 and configured to perform one or more desired functionalities described herein.

The one or more processors 512 may be composed of any suitable combination of hardware, software, or firmware to provide the desired functionality described herein. Similarly, the I/O devices 514 may include any suitable I/O devices, including, for example, a keyboard 514A, a cursor control device (e.g. mouse 514B), a display device (or monitor) 514C, a microphone, a scanner, a speaker, a printer, a network card, or any other suitable I/O device. In some embodiments, one or more of the I/O components 514 may be configured to operatively communicate with one or more external networks 540, such as a cellular telephone network, a satellite network, an information network (e.g. Internet, intranet, cellular network, cable network, fiber optic network, LAN, WAN, etc.), an infrared or radio wave communication network, or any other suitable network. The system bus 516 of the computing device 510 may represent any of the several types of bus structures (or combinations of bus structures), including a memory bus or memory controller, a peripheral bus, an accelerated graphics port, and a processor or local bus using any of a variety of bus architectures.

The memory 520 may include one or more computer-readable media configured to store data and/or program modules for implementing the techniques disclosed herein. For example, the memory 520 may host (or store) a basic input/output system (BIOS) 522, an operating system 524, one or more application programs 526, and program data 528 that can be accessed by the processor 512 for performing various functions disclosed herein.

The computing device 510 may further include a geosciences modeling package 550 in accordance with the teachings of the present disclosure. As depicted in FIG. 13, the geosciences modeling package 550 may be stored within (or hosted by) the memory 520. In alternate implementations, however, the geosciences modeling package 550 may reside within or be distributed among one or more other components or portions of the computing device 510. For example, in some implementations, one or more aspects of the geosciences modeling functionality described herein may reside in one or more of the processors 512, the I/O devices 514, the ASICs 515, or the memory 520.

As is known to persons of ordinary skill in the art, various techniques may be described in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media”.

“Computer storage media” may include volatile and non-volatile, removable and non-removable media implemented in any method or technology for storage of information such as computer readable instructions, data structures, program modules, or other data. Computer storage media may include, but is not limited to, random access memory (RAM), read only memory (ROM), electrically erasable programmable ROM (EEPROM), flash memory or other memory technology, compact disk ROM (CD-ROM), digital versatile disks (DVD) or other optical disk storage, magnetic cassettes, magnetic tape, magnetic disk storage or other magnetic storage devices, or any other medium, including paper, punch cards and the like, which can be used to store the desired information and which can be accessed by the computing device 510. Combinations of any of the above should also be included within the scope of computer readable media.

Moreover, the computer-readable media included in the system memory 520 can be any available media that can be accessed by the computing device 510, including removable computer storage media (e.g. CD-ROM 520A) or non-removeable storage media. Computer storage media may include both volatile and nonvolatile media implemented in any method or technology for storage of information such as computer-readable instructions, data structures, program modules, or other data. Generally, program modules executed on the computing device 510 may include routines, programs, objects, components, data structures, etc., for performing particular tasks or implementing particular abstract data types. These program modules and the like may be executed as a native code or may be downloaded and executed such as in a virtual machine or other just-in-time compilation execution environments. Typically, the functionality of the program modules may be combined or distributed as desired in various implementations.

It will be appreciated that the computing device 510 is merely exemplary, and represents only one example of many possible computing devices and architectures that are suitable for use in accordance with the teachings of the present disclosure. Therefore, the computing device 510 shown in FIG. 13 is not intended to suggest any limitation as to scope of use or functionality of the computing device and/or its possible architectures. Neither should computing device 510 be interpreted as having any dependency or requirement relating to any one or combination of components illustrated in the example computing device 510.

Embodiments of methods and systems for interacting with software applications in accordance with the teachings of the present disclosure may be integrated into one or more portions of the environment 500. For example, FIG. 13 further shows that the geosciences modeling package 550 may include a grid generation portion 552, a geological modeling portion 554, a reservoir modeling portion 556, and a display portion 558. One or more of the components of the geosciences modeling package 550 may be configured in accordance with the teachings of the present disclosure.

In general, unless otherwise stated herein, the components of the reservoir modeling package 550 depicted in FIG. 13 may be variously combined with one or more other components, or eliminated, to provide further possible embodiments of geosciences modeling packages in accordance with the teachings of the present disclosure. For example, in some embodiments, the grid generation portion 552 may be part of the geological modeling portion 554. Similarly, the display portion 558 may be part of the reservoir modeling portion 556, or the geological modeling portion 554, or any other portion of the geosciences modeling package 550. In further embodiments, any or all of the components of the geosciences modeling package 550 may be separated as discrete, stand alone utilities.

Also, unless otherwise specified, it will be appreciated that one or more of the components of the geosciences modeling package 550 depicted in FIG. 13 may comprise conventional components. For example, in some implementations, the geological modeling portion 554 may be a software package known as Petrel®, which is commercially-available from Schlumberger Technology Corporation. Similarly, in some implementations, the reservoir modeling portion 556 may be a conventional software package known as Eclipse®, which is also commercially-available from Schlumberger Technology Corporation.

In general, the use of methods and systems in accordance with the teachings of the present disclosure may be performed separately, or may be combined with a wide variety of utilities and applications that employ generally known techniques, and therefore will not be described in detail herein. Such known techniques include, for example, those techniques described in the following references and incorporated herein by reference: “Petrel Version 2007.1—Petrel VR Configuration and User Guide,” by Schlumberger Technology Corporation (2007); “Archiving Geological and Reservoir Simulation Models—A Consultation Document,” UK Department of Trade and Industry, (2004); “Optimal Coarsening of 3D Reservoir Models for Flow Simulation,” by King et al., SPE (Society of Petroleum Engineering) 95759 (October 2005); “Top-Down Reservoir Modeling,” by Williams et al., SPE 89974 (September 2004); and U.S. Pat. No. 6,106,561 issued to Farmer and assigned to Schlumberger Technology Corporation. Other known techniques include, for example, those techniques employed in other conventional tools, including those tools used for simulation, modeling, and display available from or produced by, for example, Gemini Solutions, Inc., BP, Chevron, Roxar, Texas A&M University, and any other suitable techniques and tools.

### CONCLUSION

Although embodiments of systems and methods for generating improved grids for performing simulations have been described in language specific to analyzing geological fractures, it is to be understood that the subject of the appended claims is not necessarily limited to the specific features or methods described.

What is claimed is:

1. A method of interacting with a software application, comprising:
operating a software application;
determining a context of usage of the software application; and
displaying a heads-up display on a display device, the heads-up display including one or more user-selectable indicators, each user-selectable indicator being associated with an operation of the software application, at least one of the one or more user-selectable indicators being displayed based on the determined context of usage.

2. The method of claim 1, wherein displaying a heads-up display on a display device comprises:
displaying a heads-up display having a plurality of user-selectable indicators circumferentially disposed about a dynamically-determined user-indicated location on the display device.

3. The method of claim 1, wherein determining a context of usage of the software application comprises:
determining one or more previous operations of the software application that have been performed; and
determining the context of usage based on the one or more previous operations.

4. The method of claim 1, wherein determining a context of usage of the software application comprises:
determining at least one preference of a user of the software application based oh one or more previous operations of the software application by the user.

5. The method of claim 4, wherein displaying a heads-up display on a display device comprises:
displaying a heads-up display on a display device, the heads-up display including one or more user-selectable indicators corresponding to the at least one determined preference of the user.

6. The method of claim 1, wherein displaying a heads-up display on a display device comprises:
displaying a heads-up display on a display device, the heads-up display including a plurality of user-selectable indicators radially spaced apart from and circumferentially disposed about a user-selectable position on the display device.

7. The method of claim 1, wherein the plurality of user-selectable indicators are radially spaced apart from the user-selectable position at a first radial distance, the method further comprising:
receiving an input associated with a selection of one of the one or more user-selectable indicators by a user; and
displaying one or more additional user-selectable indicators at a second radial distance from the user-selectable position, the second radial distance being greater than the first radial distance.

8. The method of claim 1, wherein the plurality of user-selectable indicators includes at least one of a choice icon, a menu of further user-selectable indicators, a branch structure of user-selectable indicators, a toolbar, or a pop-up window.

9. The method of claim 1, wherein determining a context of usage of the software application comprises determining a most-likely-next operation, and wherein displaying a heads-up display on a display device comprises displaying a heads-up display on a display device, the heads-up display including at least one user-selectable indicator associated with the determined most-likely-next operation.

10. The method of claim 9, wherein determining a most-likely-next operation comprises:
determining a most-likely-next operation based on a user-preference established by one or more previous operations of the software application by a user.

11. The method of claim 9, wherein displaying a heads-up display on a display device comprises:
displaying the at least one user-selectable indicator associated with the determined most-likely-next operation in an emphasized manner relative to one or more other user-selectable indicators of the heads-up display.

12. The method of claim 9, wherein displaying a heads-up display on a display device comprises:
displaying a central icon associated with a most-recently-performed operation at a user-selected position on the display device;
displaying at least one user-selectable indicator associated with the most-likely-next operation at a first radial distance from the central icon; and
displaying at least one additional user-selectable indicator associated at least one additional operation at a second radial distance from the central icon, the second radial distance being greater than the first radial distance.

13. The method of claim 12, wherein displaying at least one additional user-selectable indicator associated at least one other operation at a second radial distance from the central icon comprises:
displaying a plurality of additional user-selectable indicators at the second radial distance from, and circumferentially disposed about, the central icon.

14. A method of interacting with a software application on an electronic device, comprising:
operating the software application to establish a context of operation; and
displaying on a display device of the electronic device a heads-up display that includes one or more user-selectable indicators, each user-selectable indicator being associated with a possible operation of the software application, at least one of the one or more user-selectable indicators being displayed based on the established context of operation.

15. The method of claim 14, wherein displaying on a display device of the electronic device a heads-up display that includes one or more user-selectable indicators comprises:
displaying a heads-up display having a plurality of user-selectable indicators radially spaced apart from and circumferentially disposed about a dynamically-determined user-indicated location on the display device.

16. The method of claim 15, further comprising:
prior to displaying the heads-up display, receiving an input from a user via an interface device a signal indicative of the user-indicated location for displaying the heads-up display.

17. The method of claim 14, wherein the plurality of user-selectable indicators are radially spaced apart from the user-indicated position at a first radial distance, the method further comprising:
receiving from a user via an interface device an input associated with a selection of one of the one or more user-selectable indicators; and
displaying one or more additional user-selectable indicators at a second radial distance from the user-selectable position, the second radial distance being greater than the first radial distance.

18. The method of claim 14, further comprising:
determining a most-likely-next operation based on the established context of operation; and
wherein displaying on a display device of the electronic device a heads-up display includes displaying at least one user-selectable indicator associated with the determined most-likely-next operation in an emphasized manner relative to at least one other displayed user-selectable indicator of the heads-up display.

19. One or more non-transitory media bearing device-readable instructions that, when executed, perform a process of interacting with a software application comprising:
operating the software application to establish a context of operation; and
displaying on a display device a heads-up display having a plurality of user-selectable indicators radially spaced apart from and circumferentially disposed about a dynamically-determined user-indicated location on the display device, each user-selectable indicator being associated with an operation of the software application.

20. The one or more non-transitory media of claim 19, wherein displaying on a display device a heads-up display having a plurality of user-selectable indicators comprises:
displaying on a display device a heads-up display having a plurality of user-selectable indicators, at least one of the one or more user-selectable indicators being displayed based on the established context of operation.
